(19) United States
(12) Patent Application Publication
(10) Pub. No.: US 2020/0269641 A1
(43) Pub. Date: Aug. 27, 2020

(54) Mechanical Tire Lift

(71) Applicant: Kenneth Lee Edwards, SR., Jeanerette, LA (US)

(72) Inventor: Kenneth Lee Edwards, SR., Jeanerette, LA (US)

(21) Appl. No.: 16/283,258

(22) Filed: Feb. 22, 2019

(51) Int. Cl. B60C 25/05; B66F 5/04; B60C 25/135

(52) U.S. Cl. CPC B60C 25/0515; B66F 5/04; B60C 25/007; B60C 25/0521; B66F 2700/057; B60C 25/135

(57) ABSTRACT

The present invention provides a tire lifting device that allows an operator to lift vehicle and remove vehicle tires remotely, thereby providing a more efficient and effortless vehicle tire removal operation to the operator. The device is configured to capture, remove, replace, and minutely position vehicle wheel and tire for easy re-installation without involving lifting by the technician. The device further is powered by hydraulic and or electric operation. The device comprises a steel frame with at least at least two fixed wheels, at least one steerable wheel and drives for steering the device over surface. The device further comprises a remote control unit to perform complex motions of the device remotely. A main jack and roller stand raises and lowers the wheel and tire for height positioning, while a support tubes and tire guide hold the tire erect either for removing or remounting the vehicle tire.

### BACKGROUND OF THE INVENTION

### A. Technical Field

The present invention generally relates to a tire lifting device. More specifically, the present invention relates to a remotely controlled tire lifting device for lifting and removing vehicle tire.

### B. Description of Related Art

Construction and transportation maintains the economic viability of the world, which depends on heavy equipment. Heavy equipment moves soil, lifts beams, paves road, and serves in many other aspects of the constantly moving and building society. When the building and moving becomes large in scale, machines are utilized to take the heavy loads that are impossible for humans to manipulate. Further, all the transportation, heavy construction and moving equipment depends on the basic invention of wheel. Further, the wheels are coupled with tires to provide roll on operation. The wheel when coupled with a tire on heavy equipment becomes a considerable issue when service is required. Service technicians are required to remove, replace or repair damaged or worn wheels and tires. To remove tires from heavy equipment or trucks, the weight of the vehicle needs to be separated from the wheel and tire. Generally, jack and lifts are used to lift the equipment of the ground to gain access to the wheel and tire that requires service.

With the equipment raised off the ground, the service technician begins the process of removing the wheel and tire for the required service. Then, the tire technician loosens the nut or studs and then jacks the vehicle up to remove the tire off the hub. The wheel and tire combinations of a commercial truck can weigh up to 215 pounds. So, either more than one technician is required to lift the tire onto a dolly or some mechanical aid for the single technician is required. After the tire is removed, repaired or replaced, and re-mounted on the wheel, the tire must be reinstalled on the vehicle. Even if the tire is on a dolly and the vehicle could be raised and lowered incrementally, getting the tire positioned in such a way the studs line up could be a real chore. Further, replacing the vehicle tire in the gravel parking lot, field farm or industrial equipment exacerbates the problem more and could lead to severe back, leg, or arm strain to the technician.

Therefore, there is a need for a remotely controlled tire lifting device that removes the manual labor required to lift and remove vehicle tier and wheels.

### SUMMARY OF THE INVENTION

The present invention relates to a tire lifting device that allows a user to lift vehicle and remove vehicle tires remotely without manual labor. Thereby, the device provides a more efficient and effortless handling of vehicle tire removal operation.

The tire lifting device of the present invention comprises a frame with at least two fixed wheels and at least one steerable wheel. The device further comprises a hydraulic jack, which is configured to raise or lower a roller stand receiving the wheel and tire. The roller stand further comprises rollers that allows the tire and wheel to spin freely. The device further comprises a tire guides located at the sides of the device. The tire guides are welded to a height adjustable support tubes. The tire guides are sized to accept tires and wheel from vehicles. The device further comprises dual action cylinders to hold the tire guides upright during use and retracts the tire guides when the load such wheel and tire, is to be removed from the device.

The tire lifting device is designed to operate by remote control unit and the device functions are powered either by electric or hydraulic operations. The Tire Lifting device is positioned by the remote control unit under the mounted wheel and tire and quickly adjusted to secure the wheel and tire by utilizing the roller platform. Then, the tire lifting device is adjusted in height by the hydraulic jack. The roller platform contacts the tire and allows the tire to rotate while still mounted to the vehicle. This enables the technician to access the wheel lugs by easily rotating the wheel and tire. The tire guides secure the tire and prevent movement of the wheel and tire after the wheel nuts/lugs are removed manually. This arrangement allows the full weight of the wheel and tire to be carried by the device.

Further, on loosening the wheel and tire from the vehicle, the device could be positioned away from the vehicle utilizing a power drive of wheels and the remote control unit. The procedure is performed in reverse on re-mounting of the tire and wheel onto the vehicle.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a front perspective view of a tire lifting device in use with a vehicle in an embodiment of the present invention.

FIG. 2 shows a perspective view of the tire lifting device in operative position with a vehicle tire and wheel in an embodiment of the present invention.

FIG. 3 shows a perspective view of the remote control unit of the tire lifting device in an embodiment of the present invention.

FIG. 4 shows a top perspective view of the tire lifting device in an embodiment of the present invention.

FIG. 5 shows a side view of the tire lifting device in an embodiment of the present invention.

FIG. 6 shows a top view of the tire lifting device in an embodiment of the present invention.

FIG. 7A shows a steerable wheel with a V belt drive of the tire lifting device in an embodiment of the present invention.

FIG. 7B shows a V belt drive of the tire lifting device in an embodiment of the present invention.

FIG. 7C shows a gear assembly of the V belt drive in an embodiment of the present invention.

FIG. 8 shows a roller width drive of the tire lifting device in an embodiment of the present invention.

FIG. 9 show a front view of the remote control unit of the tire lifting device in an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

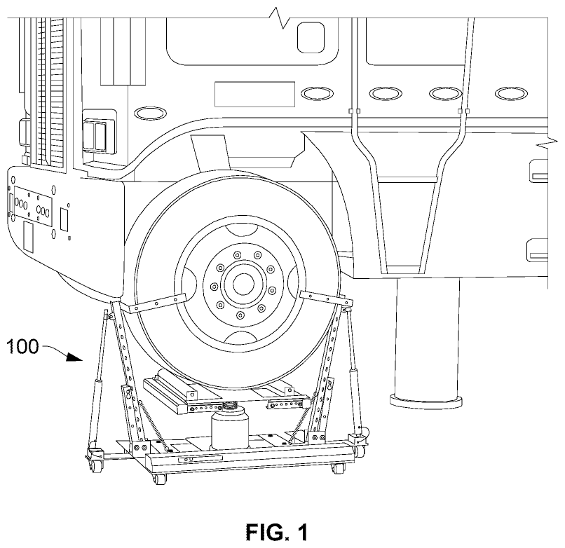

Referring to FIG. 1, the present invention discloses a tire lifting device 100 for handling tire removal from vehicles without manual labor. The tire lifting device 100 is remotely controlled to remove and replace the vehicle tire and wheel. The tire lifting device 100 is electrically and hydraulically powered to eliminate the manual handling of large, heavy and bulky wheel and tire on vehicles.

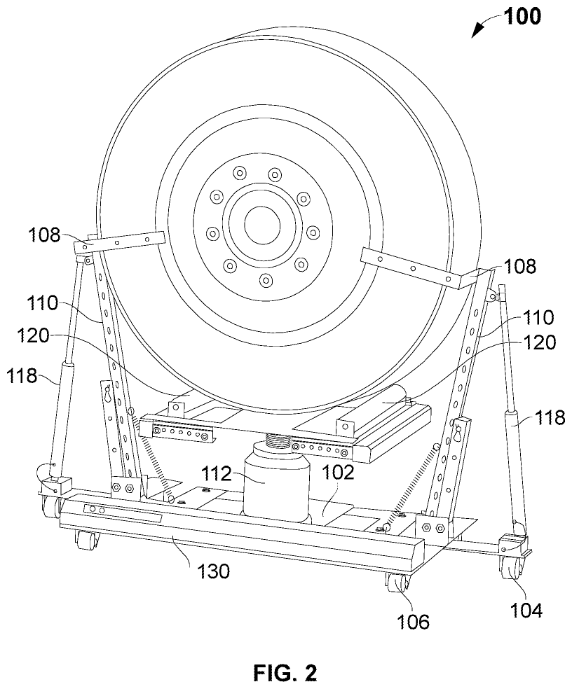

Referring to FIG. 2, the device 100 comprises a frame 102 with at least two fixed wheels 104 and at least one steerable wheel 106. The device 100 further comprises a hydraulic jack 112, which is configured to raise or lower a roller stand receiving the wheel and tire. The roller stand further comprises rollers 120 that allows the tire and wheel to spin freely. The device 100 further comprises a tire guides 108 located at the sides of the device 100. The tire guides 108 are welded to a height adjustable support tubes 110. The tire guides 108 are sized to accept tire and wheel from vehicles. The device 100 further comprises dual action cylinders 118 to hold the tire guides 108 upright during use and retracts the tire guides 108 when the load such as wheel and tire, is removed from the vehicle. In one embodiment, the tire guides 108 is configured to stabilize the wheel and tire for removal from the vehicle. The device further comprises a power and control unit 130 including on board computer or controller.

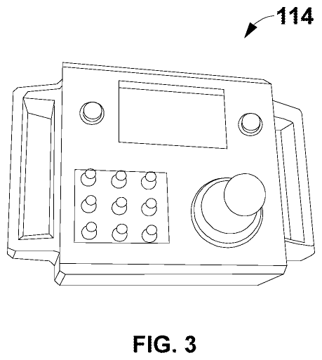

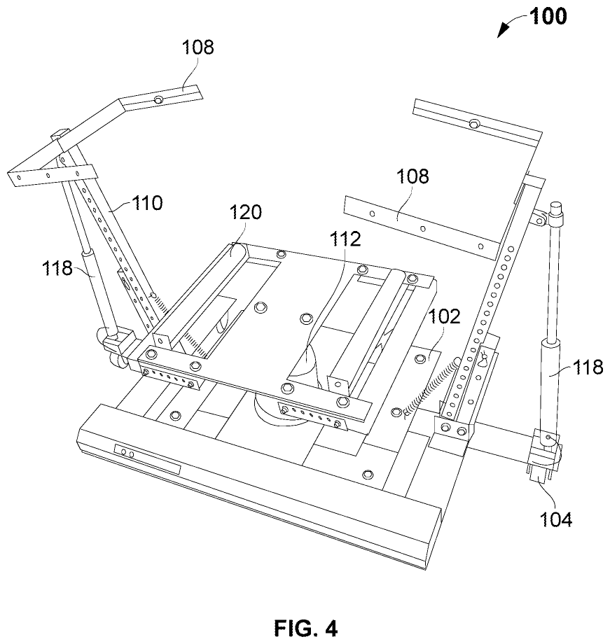

Referring to FIG. 3, the present invention further comprises a remote control unit 114 that allows an operator to position the device 100 on to the wheel and the tire of the vehicle to be serviced. Referring to FIG. 4, the perspective view of the device 100 is shown in an embodiment of the present invention.

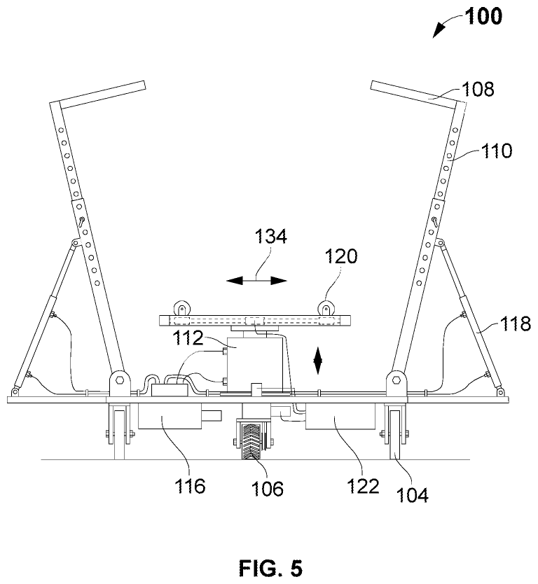

Referring to FIG. 5, the side view of the device 100 is shown in an embodiment of the present invention. The device 100 further comprises a hydraulic reservoir and electrical pump 116 to drive the central hydraulic jack 112 and the support tubes 110. The device 100 further comprises a fixed caster located under the frame 102, which balances the load using a tricycle caster system. In an embodiment, the at least two fixed wheels 104 and the at least one steerable wheel 106 makes the stable tricycle caster system to travel over the surface such as concrete, asphalt, gravel and compacted dirt surfaces. The device 100 further comprises dual action cylinders 118 to open or close the tire guides 108 on the load.

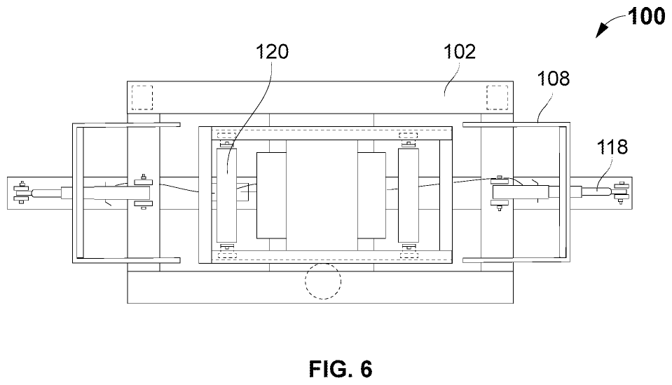

The tire guides 108 are welded to the adjustable height support tubes 110, which are pinned together using bent shaft quick release pins. The tire guides 108 are sized to accept tire and wheel from vehicles such as OTR trucks, skid steer, front tractor tires, and other similar sized industrial tires. Referring to FIG. 6 and FIG. 5, the rollers 120 are adjusted in and out direction represented by a double headed arrow 134. In one embodiment, the rollers 120 are the galvanized steel rollers. The device 100 further comprises an electronic enclosure 122, which is mounted under the frame 102 and is protected by the frame 102 from things being dropped on it. The double acting hydraulic jack 112 is under hydraulic pressure controlled by a microcomputer or a on board computer in the electronic enclosure 122 and solenoids above the hydraulic pump and reservoir 116.

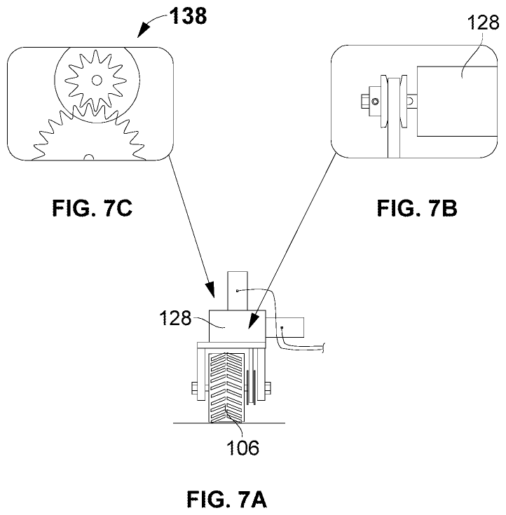

Referring to FIG. 6, a top view of the device 100 is shown in an embodiment of the present invention. In another embodiment, the tire guides 108 comprise an adjustable width guide to adjust the tire guides 108 in or out. Further the steel components of the device 100 are painted and thermally cured to provide a scratch and corrosion resistant surface. Referring to FIG. 7A, the at least one steerable wheel 106 with a V belt drive 128 of the device 100 is disclosed in an embodiment of the present invention. Referring to FIG. 7B, the V belt drive 128 moves with the device 100 in forward or reverse at various speeds as operated by the operator via the remote control unit 114. The V belt driven electrical caster is steerable by a directional motor control which can move +/−90 degrees. This makes the wiring less complicated and prevents wrapping of feed wires around the steerable wheel base. Referring to FIG. 7C, the V belt drives 128 uses gears 138 to rotate the steerable wheel 106 up to +/−90 degrees to steer the tricycle system to mount or dismount the vehicle wheel and tire.

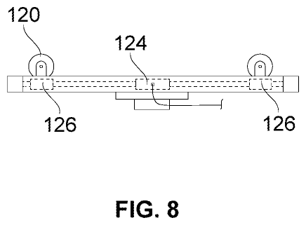

Referring to FIG. 8, a roller width drive 124 of the tire lifting device 100 is disclosed in an embodiment of the present invention. The roller width drive 124 comprises a DC motor. The rollers 120 are supported on permanently lubricated roller bearings and supports loads up to 575 pounds using a ball screw assembly with center DC motors and mated left and right hand Acme screws. The controller engages with the roller width drive 124 motor to rotate the shafts in the correct direction. A drive nuts 126 moves in or out under control of the remote control unit 114 as directed by the operator using the remote control unit 114. The operator employs swipes, pinches, and finger placements to guide the device 100 on the remote control unit 114. As the drive nut 126 moves in or out, the rollers 120 moves in or out to support the tire as directed by the operator. A two drive motors are slaved together to insure the rollers 120 move in or out at the same rate so the rollers 120 are always parallel.

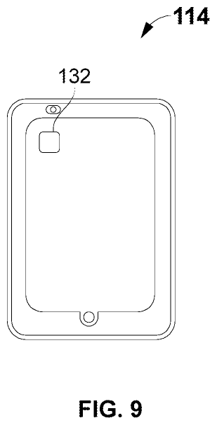

Referring to FIG. 9, the remote control unit 114 is shrouded with rubber to reduce drop shock effects and improve resiliency. In one embodiment, the remote control unit 114 is a tablet. The tablet uses the latest in processors, WiFi, and Bluetooth connectivity to converse with the device 100 effectively. Further, the remote control unit 114 comprises hardened glass touchscreen that allows operation even with mechanics gloves on the operator hand. Further the present invention uses wireless charging that allows easy recharging of the remote control unit 114.

The remote control unit 114 further comprises an icon 132 that allows easy location of the operating application, which allows full control of the device 100 over all sorts of terrain and use on distinct types of wheel and tire. The application allows control of the roller width, jack height, guide width, ground speed and direction, and allows micro-positioning of the wheel and tire for installation or removal with a dramatic reduction in physical labor. The application work with any a computing device such as a computer, tablet, or smartphone.

In one embodiment, the frame 102 of the device 100 is fabricated from 0.5″ thick cold rolled steel plate. The steel is cut to shape from sheet stock using a water jet machining center. Further, all the bolt holes and openings are formed. Furthermore, various small parts such as side support hinge plates and the double acting cylinder mounts are also cut from the 0.5″ thick sheet stock. The frame 102 is then placed in a jig and robotically welded to join all sections into one contiguous base and the small parts are also welded in place. After welding, the device 100 is powder painted and thermally cured to make a scratch and corrosion resistant surface.

In one embodiment, the support tubes 110 are cut to length from the steel and holes are formed using the water jet machining center. The support tube 110 comprises a large outer tube and a small interior tube. The larger outer tube accepts the slightly smaller interior tube. The outer tube and the interior tube have mating holes that align and accept the quick release pin to adjust the height of the tire guides 108. The lower outer tubes are drilled to accept hardened steel bolts allowing the support tubes 110 and tire guides 108 to be moved in or out under control by the dual action cylinders 118, which are controlled by the tablet working with an onboard computer.

In an embodiment, the tire guides 108 are formed using 1″ wide by 0.25″ thick steel bars, which are formed into 14″ wide by 6″ deep U channels. These channels are welded onto the upper support tubes 110 with the U opening toward the center of the device 100. The 14″ wide tire guides 108 would accommodate almost any vehicle tire and wheel including over the road wheels and tires, most farm tires, and industrial wheels/tires like skid steer units. In another embodiment, the tire guides 108 could be fabricated to adjustable in width. The back section is drilled to accept 2 bolts that retain the U shape while allowing the tire guides 108 to be adjusted in width.

In one embodiment, the steel components could be supplied in almost any vibrant color, so a distinctive color may be chosen to enhance the product recognition factor, which could dramatically improve the market adoption of the device 100. In one embodiment, the fixed wheels 104 comprises fixed casters with sealed, pre-lubricated bearings. The casters and wheels are galvanized to prevent rust and corrosion. Each caster of the fixed wheels 104 could support up to 675 pounds with a large safely margin. The combination of the fixed wheel 104 and the steerable drive wheel 106 allows the device 100 to be driven forward and backward to the optimum position to mount or dismount the wheel/tire.

In one embodiment, the steerable wheel 106 is urethane rubber coated, steel drive wheel. The drive or steerable wheel 106 is steerable at variable speed to allow easy positioning of the device 100. The DC drive motor and steering motor runs on the 18V battery are operated in conjunction under on-board computer control. The device 100 could quickly move between the vehicle and the tire repair station or could move minutely to position wheel/tire in optimum location. The steerable wheel 106 is capable of rotating ±90° from straight back and this movement is sufficient to allow micro-positioning as required. The steerable wheel 106 could support up to 1/3 of the 1,000 pound-maximum product loads with a significant safety margin.

In one embodiment, the hydraulic DC operated pump and reservoir 116 is mounted in the end of the hydraulic housing which is located under the frame 102 of the device 100. The DC pump maintains a 100 PSI pressure and comes on when the flow requirement is engaged by the computer operating the solenoid valves to move the tire guides 108 or raise or lower the jack assembly 112. The fluid flows out of or back through the solenoid valves as required and is retained in the reservoir. The reservoir has a sight glass that allows the operator to observe the fluid level in the reservoir when the device 100 is at rest.

In one embodiment, the dual action cylinders 118 are a commercially available long stroke, double acting cylinders that have the capability to move the tire guides 108 and the wheel/tire to insure proper sitting on the rollers 120 on the jack 112. The controlling computer utilizes optical position sensors in the lower pin area to determine the angle, so the tire guides 108 are positioned at similar angles on each side, insuring the wheel/tire is positioned in a center location on the rollers 120.

In one embodiment, the hydraulic jack 112 is a commercially available, double acting hydraulic jack, which has a lift stroke of 12.5″ and will lift a load of 16,000 pounds. The heavy-duty jacks 112 are made for frequent commercial use. The ram is nickel-plated for corrosion resistance and smooth operation against the seals. The double action allows for fine positional control using the tablet working in conjunction with the on-board controlling computer.

In one embodiment, the roller width drive 124 is a central bi-directional DC motor upon which Acme ball screws are mounted. The ball nuts are mounted in steel slides that move in or out as the motor is turned. The drive employs two different screws, a left and a right-handed ball screw to move the ball nuts in or out when the motor turns. There are two drive nuts 126, one on each side of the roller end, and they are synchronized to keep the rollers 120 parallel. The 13″ wide steel rollers 120 with sealed, pre-lubricated bearings are capable of supporting 575 pounds each. Having the wheel and tire on the rollers 120 allows the technician to easily rotate it to align the studs for installation after it is micro-positioned with the device 100.

In one embodiment, the onboard computer is fabricated to control the hydraulic and DC electric motors to perform the movement functions of the device 100. This ruggedized computer is placed in a sealed housing under the steel frame 102. The Bluetooth 4.0 and 802.11ac WiFi data access provides excellent and reliable uptime and the proprietary operating program allows macro and micro positioning. The controlling computer is supplied with, but not limited to, processor, memory, hard drive size, operating system, audio, ports, battery, wireless unit, Bluetooth and charging port.

In one embodiment, the remote control unit 114 is ruggedized tablet designed to use in the harsh shop environment. The thick rubber case and hardened touch screen is perfect for the maintenance operation. The remote control unit 114 comprises a fast 4G LTE broadband and 802.11ac WiFi data access to provide excellent and reliable uptime. The tablet is supplied with, but not limited to, display, processor, memory, hard drive size, operating system, media drive, audio and video unit, ports, battery, camera, wireless unit, Bluetooth and recharging unit.

In one embodiment, a PCBs of the remote control unit 114 and on board computer are fabricated based on the final assembler's requirements. The standard thickness, double sided FR4 circuit board material is populated with surface mounted components. Any through-hole devices are inserted after the surface mounted assembly, soldering, and cleaning. Both circuit boards are designed to have all the components oriented, so they can be mounted with the LED illuminators projecting out of the lenses mounted in the housings. After assembly, the PCBs are protected with a moisture adsorption preventive conformal coating.

In one embodiment, the frame 102 of the device 100 is supplied with at least two LED (Light Emitting Diode). In one embodiment, the LED is an 18-Watt LED floodlights, which is mounted on the frame 102 opposite to the steerable wheel 106 and projecting outward and slightly upward. These commercially available lights illuminate the workspace where the wheel and tire are mounted and the ground upon which the device 100 is being driven. The lights are 4″ square with aluminum heat dissipating housings. The 6-LED chip lighting modules project light out at a 60° angle providing a broad viewing angle for work and efficient nighttime operations. The LED lighting has a very long operating life and could easily withstand the harsh environment. The 12-volt lighting is operated by the on board controlling computer and is driven through a power supply operating from the 18 V battery.

The tire lifting device 100 according to the present invention, has the following advantages: allows to remove or replace wheels and tires from a vehicle; enables to operate the device 100 with a wireless remote control unit 114; rotates vehicle wheels on rollers 120 for access to wheel rugs; provides roller adjustable function for different size tires; provides an adjustable tire guides 108 for securing the wheel and tire in the device 100; eliminates manual labor of lifting wheel and tire to mount or remove; saves service technician from physical injury or strain; and provides long service of device 100 by utilizing high quality material.

Preferred embodiments of this invention are described herein, including the best mode known to the inventors for carrying out the invention. It should be understood that the illustrated embodiments are exemplary only, and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A tire lifting device, comprising:
a frame having at least two fixed wheels and at least one steerable wheel with a drive member;
a stand comprising at least two rollers disposed at opposite sides of the stand for supporting a tire and wheel on top of said rollers and in direct contact therewith for allowing said tire and wheel to rotate thereto;
a pair of adjustable support tubes disposed at opposite sides of the frame, wherein each adjustable support tube coupled to a tire guide, wherein the tire guide configured to support and stabilize the tire and wheel in upright position;
a dual action cylinder coupled to the tire guide configured to move said tire guide between an extended configuration and a retracted configuration;
a jack disposed beneath the stand for raising and lowering the stand;
a computing device in communication with the pair of adjustable support tubes, dual action cylinder, hydraulic jack and a drive member, and
a remote-control unit in communication with the computing device comprises a plurality of control member for remotely controlling the tire lifting device.

2. The tire lifting device of claim 1, wherein the remote-control unit configured to enable an operator to:
position the device beneath a vehicle requiring positioning or removal of wheel and tire, and
rotate at least two rollers to provide access to wheel lugs to either position or remove the wheel and tire from the vehicle.

3. The tire lifting device of claim 1, further comprises an adjustable width guide to adjust the tire guides in or out.

4. The tire lifting device of claim 1, further comprises drive nuts configured to move in or out under control of the remote-control unit.

5. The tire lifting device of claim 4, wherein the rollers coupled to the drive nuts configured to move in or out on movement of the drive nuts.

6. The tire lifting device of claim 1, wherein the at least one steerable wheel comprises a v belt drive to drive the device in forward or reverse direction at various speeds via the remote-control unit.

7. The tire lifting device of claim 1, wherein the drive member is a directional motor.

8. The tire lifting device of claim 1, wherein at least one steerable wheel is configured to rotate ±90° for micro-positioning of the device.

9. The tire lifting device of claim 1, wherein the jack is an electrically powered jack or a hydraulically powered jack.

10. The tire lifting device of claim 1, wherein the rollers are driven in and out utilizing at least two drive motors in communication with the computing device.

11. The tire lifting device of claim 1, wherein the computing device comprises optical position sensor to determine an angle of the tire guides to support the wheel and tire in upright position.

12. The tire lifting device of claim 1, further comprise at least two light emitting diodes in communication with the computing device, disposed at the frame to illuminate a workplace.

13. The tire lifting device of claim 1, further comprises a hydraulic reservoir and electrical pump in communication with the computing device configured to drive the jack and the pair of adjustable support tubes.

14. The tire lifting device of claim 1, wherein the rollers are galvanized steel rollers.

15. The tire lifting device of claim 1, wherein the remote-control unit is shrouded with rubber to reduce drop shock effects and improve resiliency.

16. The tire lifting device of claim 1, wherein the remote-control unit is a tablet.

17. The tire lifting device of claim 1, further comprises at least two LEDs (Light Emitting Diode) to illuminate a workspace.
